(19) United States
(12) Patent Application Publication
(10) Pub. No.: US 2025/0347643 A1
(43) Pub. Date: Nov. 13, 2025

(54) PHASE CHANGE DETERMINATION SYSTEM

(71) Applicant: I.T.E. Co., Ltd., Tokyo (JP)

(72) Inventor: Pankaj GARG, Tokyo (JP)

(73) Assignee: I.T.E. Co., Ltd., Tokyo (JP)

(21) Appl. No.: 19/200,818

(22) Filed: May 7, 2025

(30) Foreign Application Priority Data
May 8, 2024 (JP) 2024-076111

(51) Int. Cl. G01N 25/04

(52) U.S. Cl. CPC G01N 25/04

(57) ABSTRACT

Problem: To provide a phase change determination system capable of determining the occurrence of a phase change.

Solution: The phase change determination system 1 includes a temperature sensor 31 for acquiring the temperature of the phase change material 21, a database 43 for storing a reference temperature set in association with the phase change material 21, a determination unit 47 for determining whether or not a phase change has occurred in the phase change material 21 based on the acquisition result of the temperature sensor 31 and the reference temperature, and a determination unit 47 for determining whether or not a phase change has occurred in the phase change material 21 based on the acquisition result of the temperature sensor 31 and the reference temperature. The reference temperature includes a first reference temperature set at a temperature lower than or equal to the freezing point of the phase change material 21, and the determination unit 47 determines that the solidification of the phase change material 21 has begun based on the acquisition result of the temperature sensor 31 turning upward in a temperature range lower than or equal to the first reference temperature.

### RELATED APPLICATION

This application claims the benefit of priority of Japan Patent Application No. 2024-076111 filed on May 8, 2024, the contents of which are incorporated by reference as if fully set forth herein in their entirety.

### FIELD AND BACKGROUND OF THE INVENTION

This invention relates to a phase change determination system.

Conventionally, cold storage materials have been used to keep cold items (hereinafter referred to as “cold objects”) that need to be stored under refrigeration or freezing. For example, the cold storage material of Patent Document 1 includes a case and a liquid or gel-like cold storage agent filled in the case. The cold storage material is used in a frozen state, and the latent heat of fusion when the cold storage agent changes from solid to liquid keeps the storage space cold. By using cold storage agents with different freezing points (melting points), the temperature range that can be kept cold by the cold storage material can be adjusted.

### PRIOR ART DOCUMENTS

### Patent Documents

[Patent Document 1] Japanese Patent Laid-Open Publication No. 2014-219184

### SUMMARY OF THE INVENTION

### Problems to be Solved by the Invention

However, the above-mentioned cold storage materials have been difficult to determine the point in time when the cold storage material is completely frozen, that is, the point in time when the cold storage agent is completely solidified, due to factors such as the small visual change accompanying the phase change of the cold storage agent.

An object of the present invention is to provide a phase change determination system capable of determining the occurrence of a phase change.

### Means for Solving the Problems

The present invention is a determination system for determining whether or not a phase change has occurred in a target object, comprising: a temperature acquisition unit for acquiring the temperature of the target object; a storage unit for storing a reference temperature set in association with the target object; and a determination unit for determining whether or not a phase change has occurred in the target object based on the acquisition result of the temperature acquisition unit and the reference temperature, wherein the reference temperature includes a first reference temperature set to a temperature below the freezing point of the target object, and the determination unit determines that the solidification of the target object has started based on the acquisition result of the temperature acquisition unit turning upward in a temperature range below the first reference temperature.

### Effects of the Invention

According to the present invention, it is possible to provide a phase change determination system capable of determining the occurrence of a phase change.

### BRIEF DESCRIPTION OF THE SEVERAL VIEWS OF THE DRAWINGS

FIG. 1 is a schematic diagram showing the overall configuration of a phase change determination system 1 according to an embodiment.

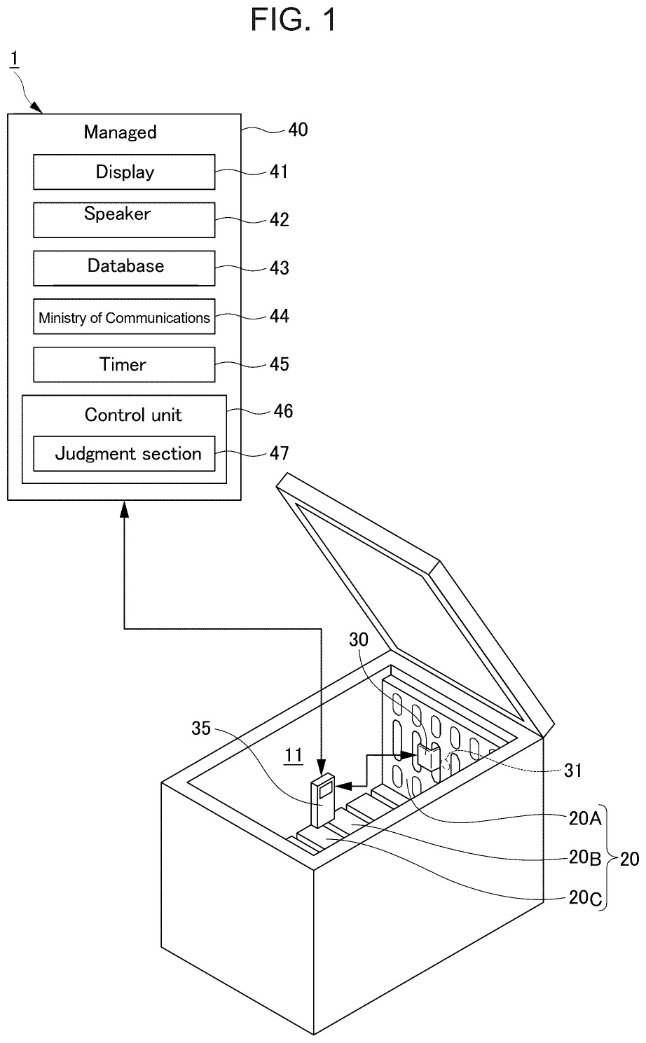

FIG. 2 is a diagram showing the results of a cooling test on a cold storage plate 20A.

FIG. 3 is a diagram showing the results of a cooling test on a cold storage plate 20B.

FIG. 4 is a diagram showing the results of a cooling test on a cold storage plate 20C.

FIG. 5 is a flowchart showing the flow of phase change determination processing.

FIG. 6 is a diagram showing a state in which frozen confectionery 70 is stored in a freezer 60 according to another example.

### DESCRIPTION OF SPECIFIC EMBODIMENTS OF THE INVENTION

Embodiments of the present invention will be described below with reference to the drawings.

The phase change determination system 1 according to the present embodiment determines the phase change of a cold storage agent 21 (corresponding to the target object) when cooling a cold storage plate 20 filled with the cold storage agent 21.

The cold storage plate 20 is for keeping cold objects cold, and corresponds to a cold storage material. The cold storage plate 20 includes a hollow box-shaped case 22 and a cold storage agent 21 filled in the case 22.

The cold storage agent 21 is composed of, for example, water having a large latent heat of fusion as a main component, to which a refrigerant (cooling agent) and a gelling agent are appropriately added, and, if necessary, a nucleating agent, a coloring agent, a preservative, and the like are added. The freezing point (melting point) of the cold storage agent 21 can be appropriately set by adjusting the type and amount of the refrigerant. This makes it possible to change the temperature range that can be kept cold by the cold storage plate 20. The freezing point of the cold storage agent 21 filled in the cold storage plate 20 is set to, for example, 0° C., −3° C., or −22° C. Hereinafter, the cold storage plate 20 having a freezing point of 0° C. for the cold storage agent 21 will be referred to as “cold storage plate 20A”. The cold storage plate 20 having a freezing point of −3° C. for the cold storage agent 21 will be referred to as “cold storage plate 20B”. The cold storage plate 20 having a freezing point of −22° C. for the cold storage agent 21 will be referred to as “cold storage plate 20C”.

It should be noted that the cold storage agent 21 of the present embodiment is different from a general cold pack made of a highly water-absorbing resin, and is a mixture of sodium chloride and a gelling agent. As a result, the cold storage agent 21 becomes a stable gel having an appropriate viscosity, and is easily maintained at a constant temperature in any temperature range. Further, the cold storage agent 21 of the present embodiment is composed of components that can keep cold for a longer time than general cold packs. Therefore, the cold storage plate 20 of the present embodiment has a superior constant temperature function for maintaining the temperature for a longer time than general cold packs. As such a cold storage plate 20, for example, Ice Battery (registered trademark) manufactured by I.T.E. Co., Ltd. can be used.

The phase change determination system 1 includes a cooling device 10, an RFID tag 30, a temperature sensor 31, a reader/writer 35, a management terminal 40, and the like.

The cooling device 10 is an ultra-low temperature freezer. The cooling device 10 includes a rectangular box-shaped main body 10a, a lid 10b that can be opened and closed and is attached to the main body 10a, and a storage space 11 surrounded by the main body 10a and the lid 10b.

The cooling device 10 cools the storage space 11 to a predetermined set temperature. The storage space 11 can accommodate the cold storage plate 20, and more specifically, can accommodate a plurality of cold storage plates 20. The cooling device 10 cools the storage space 11 to the set temperature with the cold storage plate 20 accommodated in the storage space 11. The set temperature can be set to a temperature below the freezing point of the cold storage agent 21.

The RFID tag 30 is a tag that realizes RFID (radio frequency identifier), and more specifically, a passive tag. The RFID tag 30 is provided on each of the cold storage plates 20, for example.

The temperature sensor 31 acquires the temperature of the cold storage agent 21. The temperature sensor 31 is built into the case 22, for example. The temperature sensor 31 corresponds to the temperature acquisition unit.

The RFID tag 30 and the temperature sensor 31 can communicate with each other. The RFID tag 30 sequentially acquires the acquisition result of the temperature sensor 31 from the temperature sensor 31.

The RFID tag 30 can store various information, and more specifically, can store identification information (hereinafter sometimes simply referred to as “identification information”) related to the cold storage agent 21. The identification information is set for each cold storage plate 20 containing the cold storage agent 21, for example.

The RFID tag 30 transmits a signal (sometimes referred to as “first signal”) including the acquisition result of the temperature sensor 31 and the identification information to the outside.

The reader/writer 35 wirelessly communicates with the RFID tag 30. The reader/writer 35 is arranged at a position where signals can be transmitted and received to and from the RFID tag 30, and is arranged in the storage space 11, for example. The reader/writer 35 transmits a signal (referred to as “second signal”) requesting the RFID tag 30 to transmit the first signal. When the RFID tag 30 receives the second signal, it transmits the first signal. The RFID tag 30 operates using the radio waves emitted by the reader/writer 35 as an energy source.

The reader/writer 35 wirelessly communicates with the management terminal 40. When the reader/writer 35 receives the first signal, it transmits the information included in the first signal to the management terminal 40. As a result, the acquisition result of the temperature sensor 31 and the identification information are input to the management terminal 40.

The management terminal 40 includes a display 41 for displaying various information, a speaker 42 for outputting sound, a database 43, a communication unit 44, a timer 45, and a control unit 46.

The database 43 is a storage device for storing various information, and is composed of, for example, ROM, RAM, flash memory, a solid-state drive (SSD), or a hard disk drive (HDD). The database 43 corresponds to the storage unit.

The communication unit 44 communicates with external devices. The communication unit 44 communicates with the cooling device 10 and the reader/writer 35. The communication unit 44 receives the acquisition result of the temperature sensor 31 and various information stored in the RFID tag 30 transmitted from the reader/writer 35. When the communication unit 44 receives information from the outside, it inputs the information to the control unit 46.

The timer 45 measures time. The timer 45 measures the elapsed time from a certain point in time, and when the measurement result is reset, it measures the elapsed time from the reset point in time, for example.

The control unit 46 executes various control processes. The function of the control unit 46 is realized by an arithmetic processing unit such as a CPU mounted on the management terminal 40 performing arithmetic processing while deploying software for executing the specific processing of the present embodiment to RAM or the like.

The control unit 46 controls the cooling device 10. The control unit 46 can change the set temperature of the cooling device 10. The control unit 46 can control the on/off of the cooling device 10.

The control unit 46 includes a determination unit 47 for performing various determinations. The control unit 46 (determination unit 47) executes processing (hereinafter sometimes referred to as “phase change determination processing”) for determining the occurrence of a phase change of the cold storage agent 21 when the cooling device 10 cools the cold storage plate 20.

The control unit 46 stores the information input through the communication unit 44 and the result of the phase change determination processing in the database 43. As described above, the control unit 46 controls the cooling device 10.

Here, the cold storage plate 20 is used in a state where the cold storage agent 21 is solidified in principle. The cold storage plate 20 is cooled by the cooling device 10 before use. The phase change determination system 1 determines the point in time when the solidification of the cold storage agent 21 starts and the point in time when the solidification of the cold storage agent 21 is completed by the phase change determination processing.

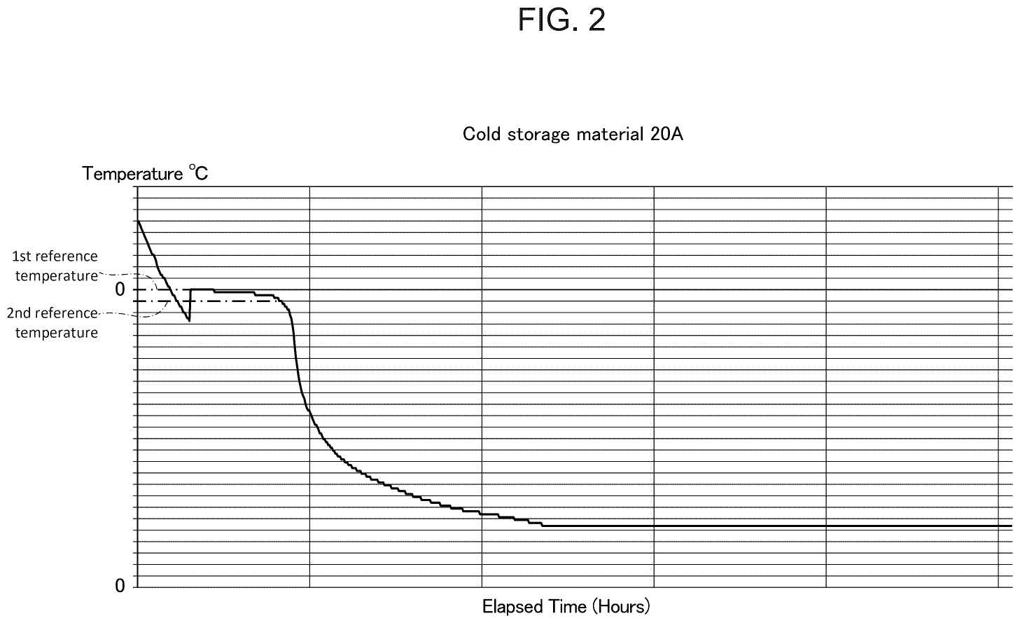

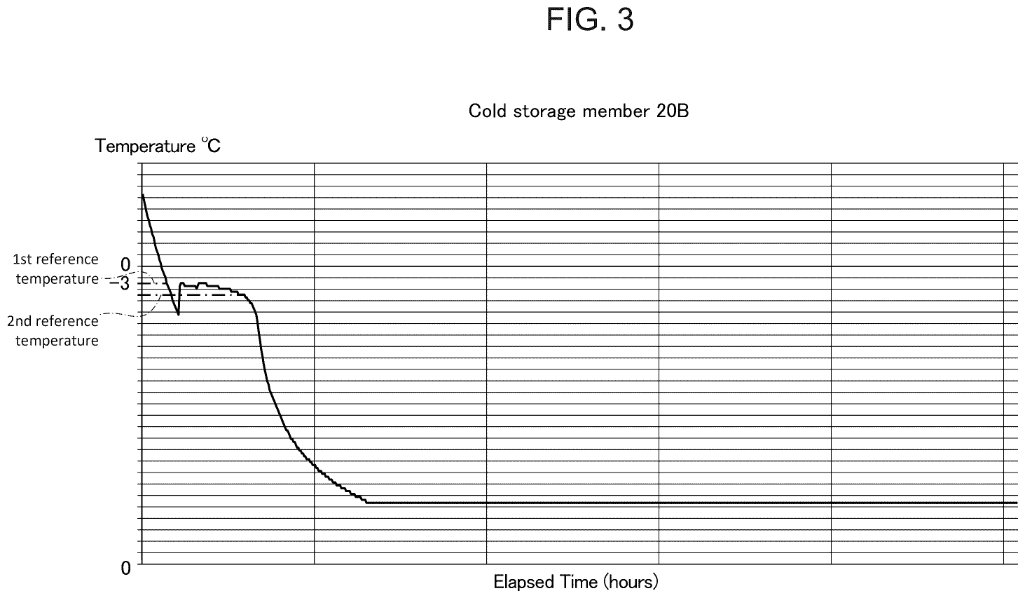

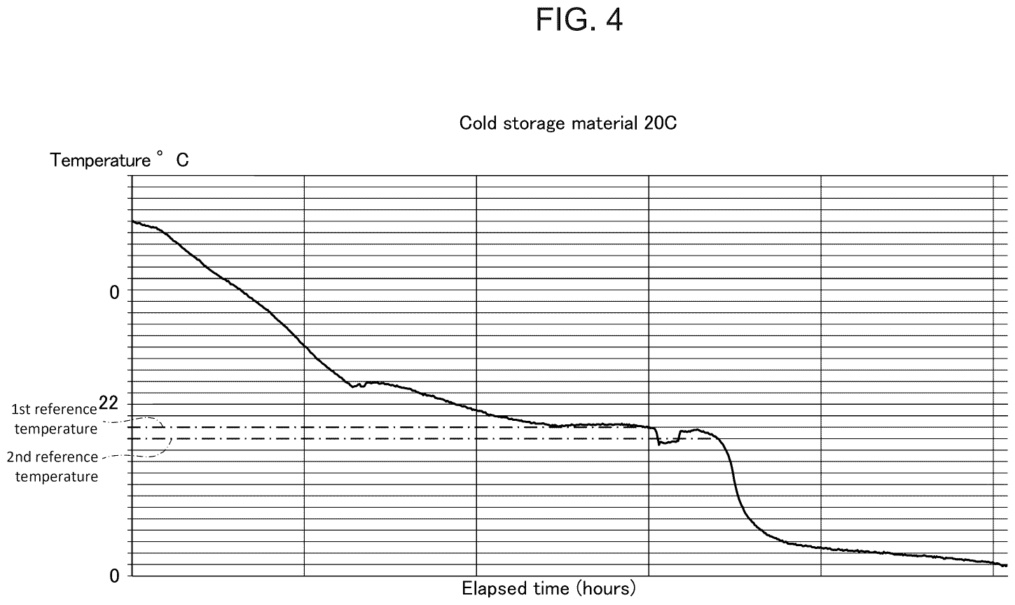

The temperature of the cold storage agent 21 at the point in time when a phase change occurs in the cold storage agent 21 differs depending on the cold storage agent 21. Therefore, a test (hereinafter referred to as “cooling test”) was conducted in which the cold storage plate 20 was cooled by the cooling device 10 in order to obtain the change over time of the temperature of the cold storage agent 21 during cooling. The results of the cooling test will be described below with reference to FIGS. 2 to 4. In FIGS. 2 to 4, the horizontal axis represents the elapsed time (time) from the point in time when the cooling of the storage space 11 by the cooling device 10 is started (hereinafter referred to as “start time”). The vertical axis represents the temperature (° C.) of the cold storage agent 21. FIG. 2 is a diagram showing the results of the cooling test on the cold storage plate 20A. FIG. 3 is a diagram showing the results of the cooling test on the cold storage plate 20B. FIG. 4 is a diagram showing the results of the cooling test on the cold storage plate 20C. In the cooling test, the set temperature is set to ultra-low temperature (−50° C.).

In the cooling test of the cold storage plate 20A, as shown in FIG. 2, the temperature of the cold storage agent 21 is higher than the freezing point of the cold storage agent 21 at the start time. At the start time, the cold storage agent 21 is all liquid.

Thereafter, the temperature of the cold storage agent 21 decreases and reaches 0° C., which is the freezing point of the cold storage agent 21. The temperature of the cold storage agent 21 continues to decrease. The cold storage agent 21 is in a supercooled state.

Thereafter, the temperature of the cold storage agent 21 turns upward at a certain point in time, and more specifically, turns upward from downward. This point in time is the point in time when the solidification of the cold storage agent 21 starts.

Thereafter, the temperature of the cold storage agent 21 rapidly rises to a temperature near the freezing point of the cold storage agent 21. Thereafter, the temperature of the cold storage agent 21 is substantially constant in the temperature range near the freezing point of the cold storage agent 21, and more specifically, gradually decreases.

Thereafter, the temperature of the cold storage agent 21 turns downward rapidly at a certain point in time. This point in time is the point in time when the solidification of the cold storage agent 21 is completed. The “point in time when the solidification of the target object is completed” refers to the point in time when the entire amount of the target object, which was at least partially liquid, becomes solid.

Thereafter, the temperature of the cold storage agent 21 decreases to a certain temperature, and then becomes substantially constant. The temperature of the cold storage agent 21 at this point in time differs depending on the set temperature.

Similarly, in the case of the cold storage plate 20B (see FIG. 3) or the cold storage plate 20C (see FIG. 4), the temperature of the cold storage agent 21 decreases to a temperature lower than the freezing point, then turns upward, then becomes substantially constant at a temperature near the freezing point (more specifically, gradually decreases), then turns downward, and then becomes substantially constant at a temperature near the set temperature.

The phase change determination system 1 executes phase change determination processing. The phase change determination processing will be described below.

A reference temperature is set when performing the phase change determination processing. The reference temperature includes a first reference temperature and a second reference temperature. The first reference temperature and the second reference temperature are set based on the results of the cooling test, for example.

The first reference temperature is set to a temperature below the freezing point, and is set to the freezing point of the cold storage agent 21, for example. The first reference temperature is set so as not to be lower than the temperature of the cold storage agent 21 at the point in time when the solidification of the cold storage agent 21 is completed.

The second reference temperature is a temperature lower than the first reference temperature and higher than the solidification start temperature of the cold storage agent 21 (the temperature at which the temperature of the cold storage agent 21 turns upward from downward). Specifically, the second reference temperature is set to a temperature equal to or lower than the temperature of the cold storage agent 21 at the point in time when the solidification of the cold storage agent 21 is completed, and more specifically, is set to the temperature of the cold storage agent 21 at the point in time when the solidification of the cold storage agent 21 is completed.

The first reference temperature and the second reference temperature are stored in the database 43. The identification information of the cold storage plate 20 and the first reference temperature and the second reference temperature relating to the cold storage agent 21 filled in the cold storage plate 20 are stored in association with each other in the database 43.

The acquisition result of the temperature sensor 31 and the identification information are sequentially input to the control unit 46 through the communication unit 44. The control unit 46 accesses the database 43 and appropriately reads out the reference temperature stored in association with the identification information.

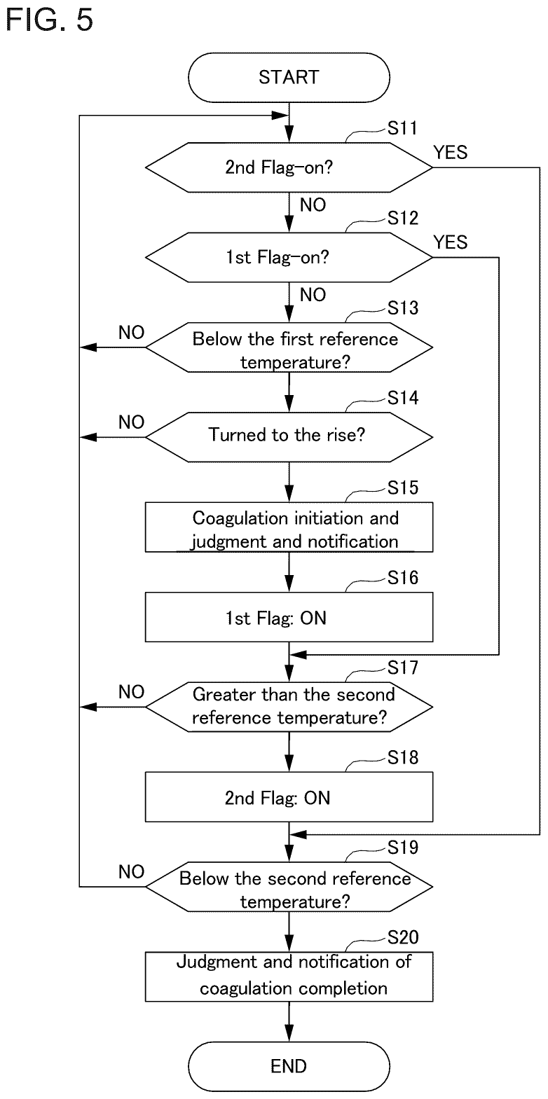

Then, the control unit 46 (determination unit 47) executes the phase change determination processing based on the acquisition result of the temperature sensor 31 and the reference temperature. The flow of the phase change determination processing will be described below with reference to FIG. 5. FIG. 5 is a flowchart showing the flow of the phase change determination processing. The control unit 46 starts the phase change determination processing at the same time as it causes the cooling device 10 to start cooling. The phase change determination processing is repeatedly executed at predetermined intervals until it is determined that the solidification of the cold storage agent 21 is completed in step S20. Further, the flowchart of FIG. 5 is executed for each cold storage plate 20 (RFID tag 30) when a plurality of cold storage plates 20 are simultaneously cooled.

In step S11, it is determined whether or not a second flag described later is on. If the second flag is on, a YES determination is made and the process proceeds to step S19. If the second flag is off, a NO determination is made and the process proceeds to step S12.

In step S12, it is determined whether or not a first flag described later is on. If the first flag is on, a YES determination is made and the process proceeds to step S17. If the first flag is off, a NO determination is made and the process proceeds to step S13.

In step S13, it is determined whether or not the acquisition result of the temperature sensor 31 is equal to or lower than the first reference temperature. At this time, the first reference temperature associated with the identification information is read out from the database 43 based on the identification information input together with the acquisition result of the temperature sensor 31 and is used. If the acquisition result of the temperature sensor 31 is equal to or lower than the first reference temperature, a YES determination is made and the process proceeds to step S14. If the acquisition result of the temperature sensor 31 is greater than the first reference temperature, a NO determination is made and the process returns to step S11, and the subsequent processing is repeated.

In step S14, it is determined whether or not the acquisition result of the temperature sensor 31 has turned upward. “Turned upward” means that, for the acquisition result of the temperature sensor 31, the latest acquisition result is higher than the previous acquisition result, and the previous acquisition result is equal to or lower than the second-to-last acquisition result. If the acquisition result of the temperature sensor 31 has turned upward, a YES determination is made and the process proceeds to step S15. If the acquisition result of the temperature sensor 31 does not correspond to the case where it has turned upward, a NO determination is made and the process returns to step S11, and the subsequent processing is repeated. The acquisition result of the temperature sensor 31 received by the management terminal 40 is stored in the database 43. The control unit 46 (determination unit 47) accesses the database 43 and refers to the past acquisition results of the temperature sensor 31 to execute the determination of this step S14.

In step S15, it is determined that the solidification of the cold storage agent 21 has started. Thus, when the acquisition result of the temperature sensor 31 turns upward in the temperature range below the first reference temperature, it is determined that the solidification of the cold storage agent 21 has started. Further, in this step S15, a notification process is executed to cause the display 41 and the speaker 42 to notify that the solidification of the cold storage agent 21 has started. As a result, the user can be notified that the solidification of the cold storage agent 21 has started. Then, the process proceeds to step S16.

In step S16, the first flag is turned on. The first flag is a flag indicating that it is after it has been determined that the solidification of the cold storage agent 21 has started. Then, the process proceeds to step S17.

In step S17, it is determined whether or not the acquisition result of the temperature sensor 31 is greater than the second reference temperature. At this time, the second reference temperature associated with the identification information is read out from the database 43 based on the identification information input together with the acquisition result of the temperature sensor 31 and is used. If the acquisition result of the temperature sensor 31 is greater than the second reference temperature, a YES determination is made and the process proceeds to step S18. If the acquisition result of the temperature sensor 31 is equal to or lower than the second reference temperature, a NO determination is made and the process returns to step S11, and the subsequent processing is repeated.

In step S18, the second flag is turned on. The second flag is a flag indicating that it is after the acquisition result of the temperature sensor 31 has become greater than the second reference temperature after it has been determined that the solidification of the cold storage agent 21 has started. Then, the process proceeds to step S19.

In step S19, it is determined whether or not the acquisition result of the temperature sensor 31 is equal to or lower than the second reference temperature. At this time, the second reference temperature associated with the identification information is read out from the database 43 based on the identification information input together with the acquisition result of the temperature sensor 31 and is used. If the acquisition result of the temperature sensor 31 is equal to or lower than the second reference temperature, a YES determination is made and the process proceeds to step S20. If the acquisition result of the temperature sensor 31 is greater than the second reference temperature, a NO determination is made and the process returns to step S11, and the subsequent processing is repeated.

In step S20, it is determined that the solidification of the cold storage agent 21 has been completed. Thus, based on the fact that the acquisition result of the temperature sensor 31 has become equal to or lower than the second reference temperature after the acquisition result of the temperature sensor 31 has become greater than the second reference temperature after it has been determined that the solidification of the target object has started, it is determined that the solidification of the cold storage agent 21 has been completed. Further, in this step S20, a notification process is executed to cause the display 41 and the speaker 42 to notify that the solidification of the cold storage agent 21 has been completed. As a result, the user can be notified that the solidification of the cold storage agent 21 has been completed. Then, this flowchart ends. When this flowchart ends, the first flag and the second flag are turned off.

The cooling device 10 may execute cooling with a plurality of cold storage plates 20 having different freezing points for the cold storage agent 21 accommodated in the storage space 11. By providing the RFID tag 30 and the temperature sensor 31 on each cold storage plate 20, even when simultaneous cooling is performed, it is possible to grasp the progress of the phase change in each cold storage plate 20 (cold storage agent 21).

According to the present embodiment described in detail above, the following excellent effects can be obtained.

According to the present embodiment, the reference temperature includes a first reference temperature set to a temperature below the freezing point of the cold storage agent 21, and the determination unit 47 determines that the solidification of the cold storage agent 21 has started based on the acquisition result of the temperature sensor 31 turning upward in the temperature range below the first reference temperature.

When a liquid object is cooled, the temperature of the object decreases to below the freezing point due to supercooling, and turns upward at a certain point in time. This point in time is the point in time when the object starts to solidify. According to the present embodiment, it is possible to identify this point in time and determine that the solidification of the cold storage agent 21 has started. Therefore, it is possible to provide a phase change determination system capable of determining the occurrence of a phase change of the cold storage agent 21.

According to the present embodiment, the reference temperature includes a second reference temperature set to a temperature equal to or lower than the temperature of the target object at the point in time when the solidification of the target object is completed, and the determination unit determines that the solidification of the target object is completed based on the fact that the acquisition result of the temperature acquisition unit has become greater than the second reference temperature after it h has been determined that the solidification of the target object has started, and then has become equal to or lower than the second reference temperature.

When an object starts to solidify, the temperature of the object rises to a temperature near the freezing point, becomes constant at that temperature, and starts to decrease at a certain point in time. This point in time is the point in time when the object has completed solidification. According to the present embodiment, it is possible to identify this point in time and determine that the solidification of the cold storage agent 21 has started.

According to the present embodiment, the phase change determination system 1 includes an RFID tag 30 for storing identification information related to the cold storage agent 21, the RFID tag 30 acquires the acquisition result of the temperature sensor 31 from the temperature sensor 31, transmits the identification information and the acquisition result of the temperature sensor 31 to the outside, the database 43 stores the identification information and the reference temperature in association with each other, and the determination unit 47 determines whether or not a phase change has occurred in the cold storage agent 21 based on the identification information, the acquisition result of the temperature sensor 31, and the reference temperature. The identification information is set for each cold storage plate 20 in which the cold storage agent 21 is filled, for example.

As a result, it is possible to appropriately determine whether or not a phase change has occurred for each cold storage plate 20.

According to the present embodiment, the phase change determination system 1 performs determination using the cold storage agent 21 filled in the cold storage plate 20 for cold storage as the target object.

The cold storage plate 20 for cold storage is used in a state where the cold storage agent 21 inside is solidified. According to the present embodiment, it is possible to efficiently prepare such a cold storage plate 20 for use.

Although the embodiments of the present invention have been described above, the present invention is not limited to the above embodiments, and can be implemented in various modes without departing from the gist of the present invention.

According to the above embodiment, the target object for which the phase change determination processing is performed was the cold storage agent 21, but it is not particularly limited thereto, and may be, for example, frozen confectionery 70. The frozen confectionery 70 is a product such as ice cream, ice milk, lacto-ice, and frozen confectionery. The target object may be a mixture of a plurality of substances having different freezing points. The freezing point of such a target object is confirmed in advance by experiments, for example.

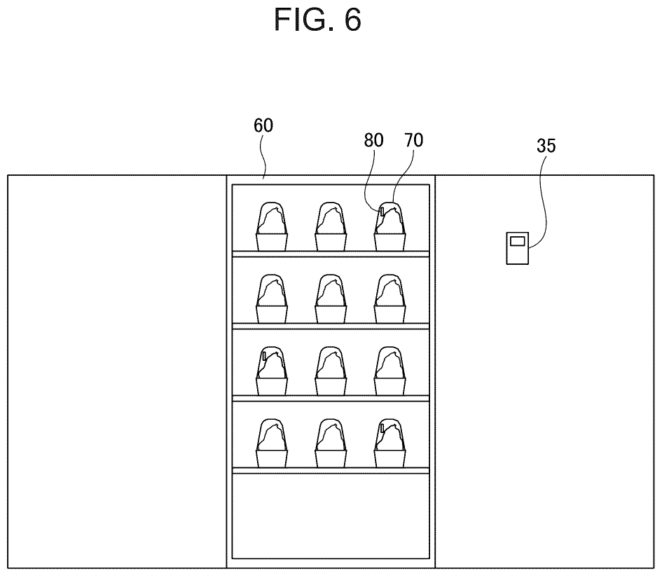

The frozen confectionery 70 may be brought to a state where the entire product is solidified in the manufacturing process in order to stabilize the shape of the product, facilitate storage and transportation, and the like. For example, as shown in FIG. 6, frozen confectionery 70, which is ice cream, is accommodated inside a freezer 60 (corresponding to a cooling device) in a state of being filled in a container. The freezer 60 executes cooling with a set temperature of low temperature (for example, −30° C.) until the solidification of the frozen confectionery 70 is completed.

In this case, it is not preferable to open the freezer 60 during cooling, and it is difficult to visually determine the completion of the solidification of the frozen confectionery 70 in the first place, so it is difficult to determine the point in time when the solidification of the frozen confectionery 70 is completed.

However, according to the phase change determination system, by providing an RFID tag and a temperature acquisition unit on the frozen confectionery 70 and making it possible to acquire the temperature of the frozen confectionery 70, it is possible to determine the point in time when the solidification of the frozen confectionery 70 is completed in the same manner as in the above embodiment.

The RFID tag may have a function of acquiring temperature. In this case, the RFID tag corresponds to the temperature acquisition unit. FIG. 6 shows an example in which an RFID tag 80 having a function of acquiring temperature is provided on the frozen confectionery 70. The RFID tag 80 does not need to be provided on all the frozen confectionery 70, and may be provided only on some of the frozen confectionery 70.

According to the above embodiment, the first reference temperature and the second reference temperature are stored in the database 43, but they may be stored in the RFID tag. In this case, the first reference temperature and the second reference temperature are transmitted to the management terminal 40 via the reader/writer 35 together with the acquisition result of the temperature acquisition unit. The management terminal 40 executes various determinations based on the first reference temperature and the second reference temperature received together with the acquisition result of the temperature sensor 31 in the phase change determination processing. In this case, the RFID tag 30 corresponds to the storage unit.

The communication between the temperature acquisition unit and the determination unit may be wireless or wired. Therefore, for example, the temperature acquisition unit may be a temperature sensor wired to the determination unit. In this case, the RFID tag 30 and the reader/writer 35 are not essential components.

According to the above embodiment, the phase change determination system 1 performed phase change determination processing for determining the phase change of the target object from liquid to solid, but it may be configured to perform phase change determination processing for determining the phase change of the target object from solid to liquid.

When the target object changes from solid to liquid, the temperature of the target object rises, and after a certain point in time, it is maintained substantially constant. This point in time is the point in time when the target object starts to melt. Thereafter, the temperature of the target object rises after a certain point in time. This point in time is the point in time when the target object has completed melting. The “point in time when the melting of the target object is completed” refers to the point in time when the entire amount of the target object, which was at least partially solid, becomes liquid.

Therefore, a third reference temperature set to a temperature equal to or higher than the freezing point of the target object and a fourth reference temperature set to a temperature higher than the third reference temperature are set. The third reference temperature is obtained experimentally, for example. The third reference temperature and the fourth reference temperature are stored in the storage unit in association with the identification information.

The determination unit determines that the object has begun to melt based on the temperature acquisition unit's acquisition result exceeding the third reference temperature. This allows the point in time when the object begins to melt to be estimated.

The determination unit determines that the object has completed melting based on the temperature acquisition unit's acquisition result exceeding the fourth reference temperature after exceeding the third reference temperature. In other words, the determination unit determines that the object has completed melting based on the temperature acquisition unit's acquisition result exceeding the fourth reference temperature after determining that the object has begun to melt. This allows the point in time when the object completes melting to be estimated. Therefore, for example, when cooling is performed using the cold storage plate 20, the point in time when the phase change material 21 completes melting can be identified, allowing the point in time when the cold storage plate 20 loses its ability to cool the surroundings to be estimated.

Each apparatus of the embodiment may be realized using cloud computing. For example, the storage unit may be a database provided on a cloud network. The management terminal 40 is not particularly limited and may be, for example, a smartphone.

The phase change determination system 1 may be capable of estimating the type of object. For example, the type of object and the first reference temperature may be stored in a database, and the type of object may be estimated based on the temperature acquisition unit's acquisition result when the temperature acquisition unit's acquisition result begins to rise and the first reference temperature.

The RFID tag may be arranged inside the cold storage plate 20. For example, a BLE (Bluetooth® Low Energy) tag that functions even at low temperatures and has waterproof properties can be arranged inside the cold storage plate 20. Incidentally, such a BLE tag has a service life of 5 to 7 years.

### LIST OF REFERENCE NUMERALS

1 Phase change determination system
20 Cold storage plate (cold storage member)
21 Phase change material (object)
30, 80 RFID tag (storage unit, temperature acquisition unit)
31 Temperature sensor (temperature acquisition unit)
41 Database (storage unit)
47 Determination unit
70 Frozen confectionery (object)

1. A determination system for determining whether or not a phase change has occurred in an object, comprising:
a temperature acquisition unit for acquiring the temperature of the object;
a storage unit for storing a reference temperature set in association with the object; and
a determination unit for determining whether or not a phase change has occurred in the object based on the acquisition result of the temperature acquisition unit and the reference temperature,
wherein the reference temperature includes a first reference temperature set at a temperature lower than or equal to the freezing point of the object, and
wherein the determination unit determines that the solidification of the object has begun based on the acquisition result of the temperature acquisition unit turning upward in a temperature range lower than or equal to the first reference temperature.

2. The determination system according to claim 1, wherein the reference temperature includes a second reference temperature set at a temperature lower than or equal to the temperature of the object at the time when the solidification of the object is completed, and
wherein the determination unit determines that the solidification of the object has been completed based on the acquisition result of the temperature acquisition unit becoming greater than the second reference temperature and then becoming lower than or equal to the second reference temperature after determining that the solidification of the object has begun.

3. A determination system for determining whether or not a phase change has occurred in an object, comprising:
a temperature acquisition unit for acquiring the temperature of the object;
a storage unit for storing a reference temperature set in association with the object; and
a determination unit for determining whether or not a phase change has occurred in the object based on the acquisition result of the temperature acquisition unit and the reference temperature,
wherein the reference temperature includes a third reference temperature set at a temperature higher than or equal to the melting point of the object, and
wherein the determination unit determines that the melting of the object has begun based on the acquisition result of the temperature acquisition unit reaching the third reference temperature.

4. The determination system according to claim 3, wherein the reference temperature includes a fourth reference temperature set at a temperature higher than the third reference temperature, and
wherein the determination unit determines that the melting of the object has been completed based on the acquisition result of the temperature acquisition unit reaching the fourth reference temperature after reaching the third reference temperature.

5. The determination system according to claim 1, further comprising:
an RFID tag for storing identification information related to the object, wherein the RFID tag acquires the acquisition result of the temperature acquisition unit from the temperature acquisition unit and transmits the identification information and the acquisition result of the temperature acquisition unit to the outside,
wherein the storage unit stores the identification information and the reference temperature in association with each other, and
wherein the determination unit determines whether or not a phase change has occurred in the object based on the identification information, the acquisition result of the temperature acquisition unit, and the reference temperature.

6. The determination system according to claim 1, wherein the object is a phase change material filled in a cold storage member for cold storage.
